(19) United States
(12) Patent Application Publication
(10) Pub. No.: US 2012/0313374 A1
(43) Pub. Date: Dec. 13, 2012

(54) ELECTRIC GENERATOR FOR A WIND TURBINE, WIND TURBINE AND METHOD OF DRIVING A WIND TURBINE

(76) Inventors: Hans Laurberg, Arhus C. (DK); Thyge Skovbjerg Thomsen, Herning (DK)

(21) Appl. No.: 13/489,678

(22) Filed: Jun. 6, 2012

(30) Foreign Application Priority Data
Jun. 10, 2011 (EP) 11169525.0

(51) Int. Cl. H02K 11/00; H02P 9/04; F03D 9/00

(52) U.S. Cl. 290/44; 310/68 B; 290/55

(57) ABSTRACT

An electric generator for a wind turbine, a wind turbine including such an electric generator and a method of driving such a wind turbine are provided. The electric generator includes a generator rotor and a generator stator concentrically arranged around a generator axis and at a distance from each other. The electric generator further includes a distance sensor arrangement including at least one distance sensor adapted to sense the distance between the generator rotor and the generator stator and to provide a sensor signal including an information about the sensed distance.

### CROSS REFERENCE TO RELATED APPLICATIONS

This application claims priority of European Patent Office application No. 11169525.0 EP filed Jun. 10, 2011. All of the applications are incorporated by reference herein in their entirety.

### FIELD OF INVENTION

An electric generator for a wind turbine, a wind turbine comprising such an electric generator and a method of driving such a wind turbine is provided.

### BACKGROUND OF INVENTION

In the field of wind turbines there is a trend to always larger wind turbine rotor sizes because the diameter of the wind rotor has a quadratic influence on the wind turbine power output. However, at the same time the forces applied to the movable parts and the supporting structure of the wind turbine increase. The resulting loads may effect the structure of the wind turbine so that the requirements for monitoring integrity and early detection of degradations of components also increases.

Moreover, with larger wind turbine rotor sizes it becomes more important to take weather conditions like wind shears into consideration in the operation of a wind turbine.

### SUMMARY OF INVENTION

It is a first objective to provide an advantageous electric generator for a wind turbine and an advantageous wind turbine. It is a second objective to provide an advantageous method of operating a wind turbine.

The first objective is solved by an electric generator and by a wind turbine. The second objective is solved by a method of operating a wind turbine. The depending claims define further developments.

The electric generator includes a generator rotor and a generator stator concentrically arranged around a generator axis and at a distance from each other. The electric generator further comprises a distance sensor arrangement including at least one distance sensor adapted to sense the distance between the generator rotor and the generator stator and to provide a sensor signal comprising an information about the sensed distance.

The distance between the generator stator and the generator rotor is commonly called the air gap. Accordingly, determining the width of the air gap and determining the position of the generator rotor relative to the generator stator are equivalent. Furthermore, since the dimensions of the generator rotor and the generator stator are known in a given application, determining any distance from which the actual air gap can be derived is considered to be included within the scope of the claims. For example, a distance between the generator rotor and the generator stator may be determined by sensing a distance between a part connected to the stator and a part connected to the rotor. Likewise, the distance between the generator rotor and the generator stator may be determined by sensing a distance between the rotor and a part connected to the stator or by sensing a distance between the stator and a part connected to the rotor.

The varying forces applied to the wind rotor propagate via the rotor shaft to the electric generator and can cause the generator rotor to temporarily deform or change its center of rotation. Moreover, the loads resulting from the forces can cause wear leading after a while to exceeding tolerances. Both can effect the air gap, i.e. the distance between the generator stator and the generator rotor. The idea that monitoring the actual air gap in the electric generator provides several advantages because variations in the rotor position in respect to the stator allow conclusions to be drawn on the actual forces applied to the wind rotor and the wind turbine rotor blades as well as on their direction of action. For example, it is possible to detect looseness or other structural problems of the electric generator main bearing by detecting a change in the dimension of the air gap. Furthermore, it can be assured that the generator rotor and the generator stator do not have physical contact which would lead to severe physical damage of the electric generator or electrical damage like short circuits. If, for example, the air gap drops below a threshold value, an emergency routine can be performed which may include a braking action, pitching the rotor blades or the like. In addition, the information about the sensed distance between the generator rotor and the generator stator can be evaluated to classify the weather conditions. For example, it may be possible to detect gusty wind which may be more dangerous to the wind turbine structure because unforeseeable variations in wind speed may occur such that it is advisable to already throttle the wind turbine output power at lower (average) wind speeds. Furthermore, it may be possible to determine wind shear when a wind direction changes and the forces acting on the wind rotor rotor blades become asymmetric.

In an embodiment of the electric generator the distance sensor arrangement comprises a first and a second distance sensor each of which having a respective sensor axis. In this embodiment a parallel projection of the sensor axis of the first distance sensor and of the sensor axis of the second distance sensor onto a plane having a surface normal parallel to the generator axis cross each other.

The presence of at least two distance sensors that are not arranged in parallel directions is sufficient to provide coordinates in as many dimensions as there are distance sensors. Thus, a number of two or more distance sensors may be used because then a position of the electric rotor can be determined in a plane whose surface normal is parallel to the generator axis.

The parallel projection of the sensor axis of the first distance sensor and of the sensor axis of the second distance sensor may cross at an angle of about or exactly 90 degrees. In this case the measurements of the two distance sensors are mutually independent which simplifies any computations required for determining the generator rotor position with respect to the generator stator.

The distance sensor arrangement may comprise a distance sensor laterally disposed from the generator axis and aligned to sense the distance in a substantially or exactly horizontal direction. The variation of wind speed is greater in a horizontal direction than in a vertical direction. Accordingly, the greatest variances of the generator rotor position will also occur in a horizontal direction. Thus, in a cost-effective solution employing a low number of distance sensors or just a single distance sensor, one distance sensor may be arranged laterally disposed from the generator axis.

The electric generator may further comprise an evaluation unit connected to the distance sensor arrangement and adapted to determine a position of the generator rotor relative to the generator stator. This embodiment of the electric generator provides information about the generator rotor position with respect to the generator stator, which can be processed by other components of the wind turbine.

In one such embodiment, the evaluation unit is adapted to determine the position of the generator rotor as

x=rₛ−x_{c}−sqrt(rᵣ²−y_{c}²);

y=rₛ−y_{c}−sqrt(rᵣ²−x_{c}²),

wherein x and y are Cartesian coordinates of the position of the generator rotor, rₛ is an inner radius of the generator stator, rᵣ is an outer radius of the generator rotor and x_{c} and y_{c} are Cartesian coordinates of the generator axis.

The coordinates computed according to the above formulae are precise but require a relatively high computational effort. For this reason in an alternative embodiment the evaluation unit is adapted to determine the position of the generator rotor as

x=rₛ−x_{c}−rᵣ;

y=rₛ−y_{c}−rᵣ,

wherein x and y are Cartesian coordinates of the position of the generator rotor, rₛ is an inner radius of the generator stator, rᵣ is an outer radius of the generator rotor and x_{c} and y_{c} are Cartesian coordinates of the generator axis. Since both rₛ and rᵣ are constants, so is their difference (rₛ−rᵣ). Hence, the Cartesian coordinates of the generator rotor can be computed requiring very little computing power or be directly derived from the distance sensors' measurements. The above formulae take advantage of the fact that x_{c} and y_{c} are much smaller than rᵣ. For this reason sqrt(rᵣ²−x_{c}²) and sqrt(rᵣ²−y_{c}²) are roughly equal to sqrt(rᵣ²)=rᵣ.

A wind turbine is also provided. The wind turbine comprises an electric generator including a generator rotor and a generator stator concentrically arranged around a generator axis and at a distance from each other. It further comprises a wind rotor connected to the generator rotor and a distance sensor arrangement including at least one distance sensor adapted to sense the distance between the generator rotor, or a part connected to the generator rotor, and the generator stator, or a part connected to the generator stator, and to provide a sensor signal comprising an information about the sensed distance.

In an embodiment of the wind turbine, the wind rotor is pivotable about a vertical axis, which is typically substantially perpendicular to a rotational axis of the wind rotor. Moreover, the wind turbine is adapted to pivot the rotor in accordance with the sensor signal from the distance sensor arrangement of the electric generator. As is known in the art, a wind turbine rotor should face the wind (in the case of an upwind design). For this reason common wind turbines comprise some means of measuring the wind direction such that the wind rotor may be pivoted to comply with the aforementioned requirement. By determining the generator rotor position (or by monitoring the air gap) a change of the wind direction or a momentary wind shear may be detected. Thus, this embodiment allows for detecting and potentially reacting to wind shear.

The wind turbine may further be adapted to compare the position of the generator rotor to at least one predetermined threshold position and to generate an alarm signal in correspondence with a result of the comparison. If the air gap drops below a specific threshold, it may be necessary to throttle the output power or brake the wind turbine altogether because the forces applied to the wind rotor and the generator rotor have reached an excessive level. Any such emergency measures can be taken following the generation of an alarm signal in this embodiment.

A method of driving the wind turbine as described above is also provided. The method comprises steps of:

sensing a distance between the generator rotor, or a part connected to the generator rotor, and the generator stator, or a part connected to the generator stator;
providing a sensor signal comprising an information about the sensed distance; and
controlling the wind turbine in correspondence with the sensor signal.

Examples of possible control actions performed in correspondence with the sensor signal may be the generation of an alarm signal, the execution of emergency routines such as braking the wind turbine, pitching the rotor blades to decrease the force applied to the wind rotor, or pivoting the wind rotor of the wind turbine to decrease wind shear.

### BRIEF DESCRIPTION OF THE DRAWINGS

Further features, properties and advantages will become clear from the following description of embodiments in conjunction with the accompanying drawings.

FIG. 1 schematically shows a wind turbine.

FIG. 2 shows a first embodiment of an electric generator.

FIG. 3 shows a second embodiment of an electric generator.

### DETAILED DESCRIPTION OF INVENTION

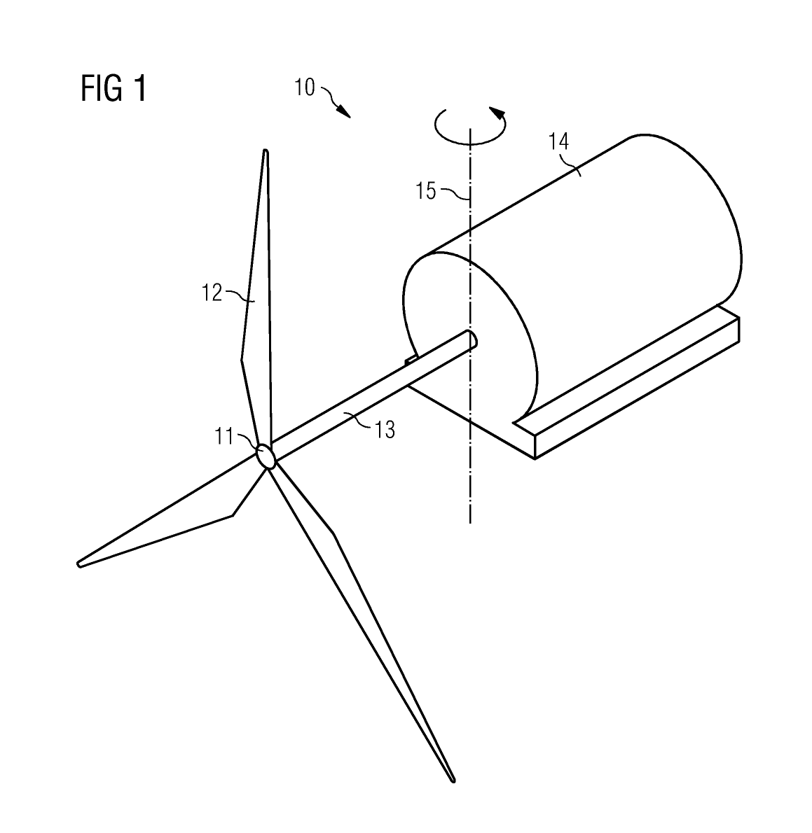

FIG. 1 shows a wind turbine 10. The wind turbine 10 includes a wind turbine rotor 11 which in this exemplary embodiment has three rotor blades 12. As is common knowledge in the art, any number of rotor blades 12 can be used, however, for various reasons three rotor blades are generally accepted as being an optimal choice. The wind rotor 11 is connected to an electric generator 14 by means of a rotor shaft 13 which transmits the rotational power provided by the wind rotor 11 to the electric generator 14. The electric generator 14 transforms the mechanical power into electric power. In some embodiments a transmission including gears may be used to transmit torque from the wind rotor 11 to the electric generator 14, however, such a transmission system entails extra costs and weight and thus may be avoided.

The wind rotor 11, the rotor shaft 13 and the electric generator 14 may be installed at the top of a tower or other support structure not shown in the figure. In this case the wind turbine 10 is a horizontal-axis wind turbine. Nonetheless, it is also possible to implement the wind turbine as a vertical-axis wind turbine. However, within this document only a horizontal-axis wind turbine will be described.

The wind turbine rotor 11 is pivotable about a vertical axis 15 in order to be able to orientate the wind rotor 11 of the wind turbine 10 towards the actual wind direction.

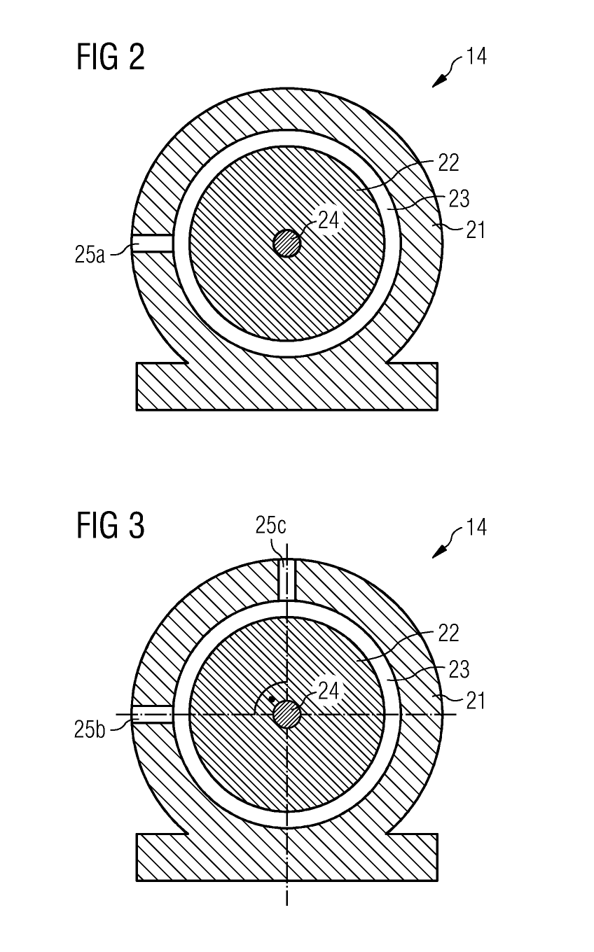

FIG. 2 shows a first embodiment of an electric generator 14 which may be used in the wind turbine 10 of FIG. 1. The electric generator 14 generally includes a generator stator 21 and a generator rotor 22. The fundamental principle of an electric generator is well-understood in the art and therefore will not be explained herein. The generator stator 21 may include a base for installing the generator stator 21. In the example of FIGS. 2 and 3, the generator rotor 22, that is about a generator axis 24, is installed within the generator stator 21 (internal rotor) and may be either directly or indirectly connected to the rotor shaft 13. However, all embodiments may be implemented in an alternative way where the generator stator is installed within the generator rotor 22 which then rotates around the generator stator (external rotor).

During operation the generator rotor 22 will rotate about the generator axis 24. Since the generator stator 21 does not move during operation, an air gap 23 is required to separate the gyrating generator rotor 22 from the generator stator 21. Forces transmitted from the wind rotor 11 to the generator rotor 22 may cause the generator rotor 22 to temporarily or permanently change position which causes a corresponding change in the width of the air gap 23. In order to avoid contact between the generator rotor 22 and the generator stator 21 the air gap 23 can be made large, however, a larger air gap affects generator efficiency. The air gap 23 may be monitored. In the first embodiment shown in FIG. 2 a distance sensor 25a is arranged on the generator stator 21. Generally, the distance sensors may be equivalently arranged on the generator stator 21 or on the generator rotor 22, however, when the distance sensor is installed on the generator stator 21, transmission of the distance sensor signal outside the electric generator 14 is facilitated.

The distance sensor 25a is adapted to measure a distance to the generator rotor 22 and thus a width of the air gap 23. The information about the actual width of the air gap 23 provides for a number of advantages. As has already been pointed out, it becomes possible to determine a deviation of the current wind direction from the wind turbine rotor orientation (wind shear) and thus to re-orientate the wind rotor 11 correctly.

The first embodiment of the electric generator 14 includes a single distance sensor 25a only and therefore represents a low-cost solution. Since the wind moves primarily parallel to the ground even at the height of the wind rotor 11, the wind direction will also vary mostly in a horizontal plane. For this reason the deviations of the generator rotor 22 position will be the greatest in a lateral direction which is why the distance sensor 25a is laterally disposed from the generator axis 24 in the first embodiment. It is safe to assume that as long as the air gap 23 measured at the site of the distance sensor 25a remains within safe boundaries, it will also at any other place in the electric generator 14.

However, generally any number of distance sensors may be present in the electric generator 14. A higher number of distance sensors provides for a more precise measurement of the air gap and also for measurements of the air gap at different locations. If there are N sensors providing measurements m₁, m₂, . . . , m_{N}, the position [x_{c}, y_{c}] of the generator rotor 21 can be estimated as [x_{c}, y_{c}]=argmin_{x,y}(e([d₁(x, y), d₂(x, y), . . . , d_{N}(x, y), [m₁, m₂, . . . , m_{N}])),

wherein d₁, d₂, . . . , d_{N} are functions that return the distance of a specific sensor for a given generator rotor position and e( ) is a distance measure such as the Euclidian norm. If the distance sensors are not distributed evenly, it may be beneficial to use a distance measure where the distance sensors closely located have less influence on e( ).

Generally, the distance sensor(s) can be of any available type such as inductance, light or sound-based designs.

FIG. 3 shows a second embodiment of an electric generator 14. Items having identical numerals as items in FIG. 2 are identical or functionally equivalent to those in FIG. 2. Redundant description of them will be omitted for the sake of conciseness.

The second embodiment largely corresponds to the first embodiment of FIG. 2 but comprises two distance sensors 25b and 25c. The two distance sensors 25b and 25c are arranged in such a way that their respective sensor axes cross in the sectional plane through the electric generator 14 of FIG. 3. The sensor axes may cross at a rectangular angle. The use of two distance sensors 25b, 25c allows for determining the position of the generator rotor 22 in two dimensions which makes is possible to determine the width of the air gap 23 at any place in the circumference of the generator rotor 22. If the two distance sensors 25b, 25c are arranged perpendicularly to each other, their measurements become linearly independent facilitating the computation of the position of the generator rotor 22.

While specific embodiments have been described in detail, those with ordinary skill in the art will appreciate that various modifications and alternative to those details could be developed in light of the overall teachings of the disclosure. Accordingly, the particular arrangements disclosed are meant to be illustrative only and not limiting as to the scope of the invention, which is to be given the full breadth of the appended claims, and any and all equivalents thereof.

We claim:

1. An electric generator for a wind turbine, comprising:
a generator rotor and a generator stator concentrically arranged around a generator axis and at a distance from each other; and
a distance sensor arrangement including at least one distance sensor adapted to sense the distance between the generator rotor and the generator stator and to provide a sensor signal comprising an information about the sensed distance.

2. The electric generator of claim 1,
wherein the distance sensor arrangement comprises a first and a second distance sensor each of which having a respective sensor axis, and
wherein a parallel projection of the first sensor axis of the first distance sensor and of the second sensor axis of the second distance sensor onto a plane having a surface normal parallel to the generator axis cross each other.

3. The electric generator of claim 2, wherein the parallel projection of the first sensor axis of the first distance sensor and of the second sensor axis of the second distance sensor cross at an angle of about or exactly 90 degrees.

4. The electric generator of claim 1, wherein the distance sensor arrangement comprises a distance sensor laterally disposed from the generator axis and aligned to sense the distance in a substantially or exactly horizontal direction.

5. The electric generator of claim 4, further comprising an evaluation unit connected to the distance sensor arrangement and adapted to determine a position of the generator rotor relative to the generator stator.

6. The electric generator of claim 5, wherein the evaluation unit is adapted to determine the position of the generator rotor as
x=rₛ−x_{c}−sqrt(rᵣ²−y_{c}²),
y=rₛ−y_{c}−sqrt(rᵣ²−x_{c}²),
wherein x and y are Cartesian coordinates of the position of the generator rotor, rₛ is an inner radius of the generator stator, rᵣ is an outer radius of the generator rotor and x_{c} and y_{c} are Cartesian coordinates of the generator axis.

7. The electric generator of claim 5, wherein the evaluation unit is adapted to determine the position of the generator rotor as
x=rₛ−x_{c}−rᵣ,
y=rₛ−y_{c}−rᵣ,
wherein x and y are Cartesian coordinates of the position of the generator rotor, rₛ is an inner radius of the generator stator, rᵣ is an outer radius of the generator rotor and x_{c} and y_{c} are Cartesian coordinates of the generator axis.

8. A wind turbine, comprising:
an electric generator including a generator rotor and a generator stator concentrically arranged around a generator axis and at a distance from each other;
a wind rotor connected to the generator rotor; and
a distance sensor arrangement including a distance sensor adapted to sense the distance between the generator rotor, or a part connected to the generator rotor, and the generator stator, or a part connected to the generator stator, and to provide a sensor signal comprising an information about the sensed distance.

9. The wind turbine of claim 8,
wherein the distance sensor arrangement comprises a first and a second distance sensor each of which having a respective sensor axis, and
wherein a parallel projection of the first sensor axis of the first distance sensor and of the second sensor axis of the second distance sensor onto a plane having a surface normal parallel to the generator axis cross each other.

10. The wind turbine of claim 9, wherein the parallel projection of the first sensor axis of the first distance sensor and of the second sensor axis of the second distance sensor cross at an angle of about or exactly 90 degrees.

11. The wind turbine of claim 8, wherein the distance sensor arrangement comprises a distance sensor laterally disposed from the generator axis and aligned to sense the distance in a substantially or exactly horizontal direction.

12. The wind turbine of claim 11, further comprising an evaluation unit connected to the distance sensor arrangement and adapted to determine a position of the generator rotor relative to the generator stator.

13. The wind turbine as claimed in claim 12,
wherein the wind turbine is adapted to compare the position of the generator rotor to a predetermined threshold position and to generate an alarm signal in correspondence with a result of the comparison.

14. The wind turbine of claim 12, wherein the evaluation unit is adapted to determine the position of the generator rotor as
x=rₛ−x_{c}−sqrt(rᵣ²−y_{c}²),
y=rₛ−y_{c}−sqrt(rᵣ²−x_{c}²),
wherein x and y are Cartesian coordinates of the position of the generator rotor, rₛ is an inner radius of the generator stator, rᵣ is an outer radius of the generator rotor and x_{c} and y_{c} are Cartesian coordinates of the generator axis.

15. The wind turbine of claim 12, wherein the evaluation unit is adapted to determine the position of the generator rotor as
x=rₛ−x_{c}−rᵣ,
y=rₛ−y_{c}−rᵣ,
wherein x and y are Cartesian coordinates of the position of the generator rotor, rₛ is an inner radius of the generator stator, rᵣ is an outer radius of the generator rotor and x_{c} and y_{c} are Cartesian coordinates of the generator axis.

16. The wind turbine as claimed in claim 8,
wherein the wind rotor is pivotable about a vertical axis, and
wherein the wind turbine is adapted to pivot the wind rotor in accordance with the sensor signal from the distance sensor arrangement of the electric generator.

17. A method of operating a wind turbine according claim 8, the method comprising:
sensing a distance between the generator rotor, or a part connected to the rotor, and the generator stator, or a part connected to the generator stator;
providing a sensor signal comprising an information about the sensed distance; and
controlling the wind turbine in correspondence with the sensor signal.
